(19) United States
(12) Patent Application Publication
(10) Pub. No.: US 2026/0138227 A1
(43) Pub. Date: May 21, 2026

(54) COMPENSATION VALUE CALCULATION METHOD OF POSITION MEASUREMENT SENSOR AND COMPENSATION VALUE CALCULATION SYSTEM OF POSITION MEASUREMENT SENSOR IN MACHINE TOOL

(71) Applicant: OKUMA CORPORATION, Niwa-Gun (JP)

(72) Inventors: Yasunori KONDO, Niwa-Gun (JP); Tetsuya MATSUSHITA, Niwa-Gun (JP); Reiji KANBE, Niwa-Gun (JP)

(73) Assignee: OKUMA CORPORATION, Niwa-Gun (JP)

(21) Appl. No.: 19/387,769

(22) Filed: Nov. 13, 2025

(30) Foreign Application Priority Data
Nov. 21, 2024 (JP) 2024-203459

(51) Int. Cl. B23Q 17/22; G01D 18/00

(52) U.S. Cl. CPC B23Q 17/22; G01D 18/00; G01D 2218/10

(57) ABSTRACT

A compensation value calculation method of a position measurement sensor in a machine tool includes a tool sensor sensing position measuring step, a position measurement sensor length calculating step, a relative position obtaining step, a reference tool distal end position measuring step, a tool sensor position measuring step, and a position measurement sensor length direction compensation value calculating step.

### CROSS REFERENCE TO RELATED APPLICATION

This application claims the benefit of Japanese Patent Application Number 2024-203459 filed on Nov. 21, 2024, the entirety of which is incorporated by reference.

### FIELD OF THE INVENTION

The disclosure relates to a compensation value calculation method of a position measurement sensor and a compensation value calculation system of the position measurement sensor in a machine tool, the method and the system are for calculating a compensation value of the position measurement sensor used for measuring a position of a workpiece in the machine tool in which a table holding the workpiece and a main spindle holding a tool move relative to each other along translational axes.

### BACKGROUND OF THE INVENTION

In a numerical control machine tool M with three translational axes as illustrated in FIG. 1, when a workpiece set on a table 3 is machined using a tool mounted to a main spindle 2, a reference position for machining the workpiece needs to be recorded in a control device in advance. The reference position for the machining is obtained, for example, by measuring a position of the workpiece.

A known method of measuring a position of a workpiece is a method using a touch trigger probe that is a position measurement sensor mounted to a main spindle. At the moment when a stylus attached to the touch trigger probe comes into contact with the workpiece, a signal is transmitted. An NC control device installed in a machine tool receives the signal by a connected receiver. When the signal is received, the NC control device calculates the position of the workpiece by using a compensation value in a length direction of the touch trigger probe in addition to positions of the respective axes at the time.

However, the touch trigger probe undergoes changes over time, for example, a thermal distortion due to a change of room temperature. Therefore, to accurately measure the workpiece position, it is necessary to appropriately reobtain the compensation value in the length direction of the touch trigger probe.

As a method of calculating the compensation value in the length direction of the touch trigger probe, the applicant discloses a method as described in JP 7266511 B.

In the method described in JP 7266511 B, a tool sensor, such as a laser sensor and a touch sensor, a reference block installed on a base of the tool sensor, and a reference tool having a known length are used. Preliminarily, a sensing position of the tool sensor, a relative position of the reference block with respect to the sensing position, and a compensation value in a length direction of a touch trigger probe are obtained. Then, by measuring a sensing position of the reference tool with the tool sensor, and measuring a position of the reference block with the touch trigger probe, the compensation value in the length direction of the touch trigger probe can be calculated.

However, when the preliminarily obtained relative position of the reference block with respect to the sensing position of the tool sensor changes, an error of the compensation value in the length direction of the touch trigger probe is generated in some cases. Therefore, in JP 7266511 B, the reference block is installed on the same base as the tool sensor, thereby decreasing the change of the relative position. However, for example, in a case where a coefficient of linear expansion is different between the tool sensor and the reference block, even when the tool sensor and the reference block are installed on the same base, the relative position changes corresponding to the change of surrounding temperature. As a result, there is still an issue in the generation of the error in the compensation value in the length direction of the touch trigger probe.

Further, as described in JP 7266511 B, the tool sensor and the reference block are often separately provided, and are each installed at any position on a table. Therefore, it has been desired to solve an issue of a narrowed table region on which the workpiece is placed.

Therefore, it is an object of the disclosure to provide a compensation value calculation method of a position measurement sensor and a compensation value calculation system of the position measurement sensor in a machine tool capable of reducing an error generated in a compensation value in a length direction of a position measurement sensor to minimum regardless of a change of surrounding temperature and capable of increasing a table region on which a workpiece is placed.

### SUMMARY OF THE INVENTION

To solve the above-described issues, a first configuration of the disclosure is a compensation value calculation method of a position measurement sensor in a machine tool for calculating a compensation value in a length direction of the position measurement sensor. The machine tool includes a table configured to hold a workpiece, a rotatable main spindle to which a tool is mounted, a translational axis configured to perform a relative motion of the main spindle and the table with two degrees or more of translational freedom, and a tool sensor configured to measure a position of the tool mounted to the main spindle. The machine tool is configured to measure a position of the workpiece held by the table with the position measurement sensor mountable to the main spindle. The tool sensor includes a sensing portion that senses a sensing object and a reference portion that is provided integrally with the tool sensor in a proximity of the sensing portion and serves as a position reference of the tool sensor.

The method includes: a tool sensor sensing position measuring step of mounting a reference tool having a known length to the main spindle, causing the sensing portion of the tool sensor to sense a distal end of the reference tool to obtain a distal end position of the reference tool, and measuring a position of the sensing portion of the tool sensor from the obtained distal end position of the reference tool and a length of the reference tool;
a position measurement sensor length calculating step of obtaining a reference position using the reference tool mounted to the main spindle, subsequently, mounting the position measurement sensor to the main spindle, measuring the reference position using the position measurement sensor to obtain a position-measurement-sensor-reference-position, and calculating a length of the position measurement sensor from the obtained position-measurement-sensor-reference-position, the length of the reference tool, and the reference position;
a relative position obtaining step of mounting the position measurement sensor to the main spindle, measuring a position of the reference portion, and obtaining a relative position of the position of the reference portion with respect to the position of the sensing portion from the measured position of the reference portion, the position of the sensing portion measured in the tool sensor sensing position measuring step, and the length of the position measurement sensor calculated in the position measurement sensor length calculating step;
a reference tool distal end position measuring step of mounting the reference tool to the main spindle, bringing the distal end of the reference tool into contact with the sensing portion, and measuring a position of the distal end of the reference tool;
a tool sensor position measuring step of measuring a position of the tool sensor by mounting the position measurement sensor to the main spindle and measuring the position of the reference portion; and
a position measurement sensor length direction compensation value calculating step of calculating the compensation value in the length direction of the position measurement sensor from the length of the reference tool, the relative position obtained in the relative position obtaining step, the position of the distal end of the reference tool measured in the reference tool distal end position measuring step, and the position of the tool sensor measured in the tool sensor position measuring step.

In another aspect of the first configuration of the disclosure, which is in the above configuration, the tool sensor sensing position measuring step to the relative position obtaining step are executed once, and the reference tool distal end position measuring step to the position measurement sensor length direction compensation value calculating step are executed multiple times.

In another aspect of the first configuration of the disclosure, which is in the above configuration, the sensing portion and the reference portion are formed of a material that does not cause a change of the relative position between the sensing portion and the reference portion in an environmental temperature range observed in the machining by the machine tool.

To solve the above-described issues, a second configuration of the disclosure is a compensation value calculation system of a position measurement sensor in a machine tool for calculating a compensation value in a length direction of the position measurement sensor. The machine tool includes a table configured to hold a workpiece, a rotatable main spindle to which a tool is mounted, a translational axis configured to perform a relative motion of the main spindle and the table with two degrees or more of translational freedom, a control device that controls the table, the translational axis, and the main spindle, and a tool sensor configured to measure a position of the tool mounted to the main spindle. The machine tool is configured to measure a position of the workpiece held by the table with the position measurement sensor mountable to the main spindle. The tool sensor includes a sensing portion that senses a sensing object and a reference portion that is provided integrally with the tool sensor in a proximity of the sensing portion and serves as a position reference of the tool sensor.

The system includes
a reference tool having a known length;
a tool sensor sensing position measuring unit that mounts the reference tool to the main spindle, operates the translational axis, causes the sensing portion of the tool sensor to sense a distal end of the reference tool to obtain a distal end position of the reference tool, and measures a position of the sensing portion of the tool sensor from the obtained distal end position of the reference tool and a length of the reference tool;
a position measurement sensor length calculating unit that mounts the reference tool to the main spindle and operates the translational axis to obtain a reference position, subsequently, mounts the position measurement sensor to the main spindle, operates the translational axis to measure the reference position using the position measurement sensor to obtain a position-measurement-sensor-reference-position, and calculates a length of the position measurement sensor from the length of the reference tool, the reference position, and the position-measurement-sensor-reference-position;
a relative position obtaining unit that mounts the position measurement sensor to the main spindle, operates the translational axis to measure a position of the reference portion, and obtains a relative position of the position of the reference portion with respect to the position of the sensing portion from the measured position of the reference portion, the position of the sensing portion measured by the tool sensor sensing position measuring unit, and the length of the position measurement sensor calculated by the position measurement sensor length calculating unit;
a reference tool distal end position measuring unit that mounts the reference tool to the main spindle, operates the translational axis to bring the distal end of the reference tool into contact with the sensing portion, and measures a position of the distal end of the reference tool;
a tool sensor position measuring unit that measures a position of the tool sensor by mounting the position measurement sensor to the main spindle and operating the translational axis to measure the position of the reference portion; and
a position measurement sensor length direction compensation value calculating unit that calculates the compensation value in the length direction of the position measurement sensor from the length of the reference tool, the relative position obtained by the relative position obtaining unit, the position of the distal end of the reference tool measured by the reference tool distal end position measuring unit, and the position of the tool sensor measured by the tool sensor position measuring unit.

In another aspect of the second configuration of the disclosure, which is in the above configuration, the sensing portion and the reference portion are formed of a material that does not cause a change of the relative position between the sensing portion and the reference portion in an environmental temperature range observed in the machining by the machine tool.

According to the disclosure, by providing the reference portion integrated with the tool sensor in the proximity of the sensing portion, the change of the relative position can be decreased even when the surrounding temperature changes. Accordingly, in the calculation of the compensation value in the length direction of the position measurement sensor using the relative position between the position of the sensing portion and the position of the reference portion on the tool sensor, the error generated in the compensation value in the length direction of the position measurement sensor can be minimized. Further, since the reference block separated from the tool sensor is not necessary, the table region on which the workpiece is placed can be increased.

Furthermore, since the sensing portion and the reference portion are formed of a material that does not cause a change of the relative position between the sensing portion and the reference portion in an environmental temperature range observed in the machining by the machine tool, the relative position change due to the temperature change can be more decreased.

### BRIEF DESCRIPTION OF THE DRAWINGS

FIG. 1 is an explanatory view illustrating a compensation value calculation system of a position measurement sensor according to the disclosure.

FIG. 2 is a block diagram illustrating a configuration of an NC control device.

FIG. 3 is an explanatory view illustrating a laser sensor according to the disclosure.

FIG. 4 is an explanatory view illustrating a touch sensor according to the disclosure.

FIG. 5 is an explanatory view of measurement of a reference position of a table top surface using a touch trigger probe.

FIG. 6 is a flowchart of a setting in advance of calculation of a compensation value in a length direction of the touch trigger probe according to the disclosure.

FIG. 7 is an explanatory view of obtainment of the reference position of the table top surface using a reference tool.

FIG. 8 is an explanatory view of measurement of a position of a reference portion of the laser sensor.

FIG. 9 is an explanatory view of measurement of a position of a reference portion of the touch sensor.

FIG. 10 is a flowchart of a calculation method of the compensation value in the length direction of the touch trigger probe according to the disclosure.

### DETAILED DESCRIPTION OF THE INVENTION

The following describes embodiments of the disclosure based on the drawings.

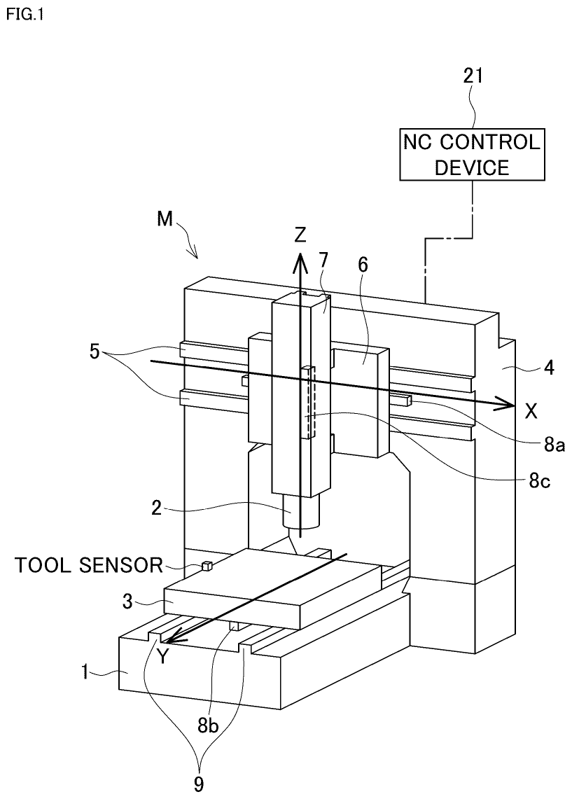

In the embodiment, as illustrated in FIG. 1, a machining center-based numerical control machine tool M with three translational axes of an X-axis, a Y-axis, and a Z-axis is used as an example of a machine tool. However, as a machine tool, another machine, such as a multi-axis control machine tool with a rotation axis in addition to translational axes and a lathe-based numerical control machine tool, may be used.

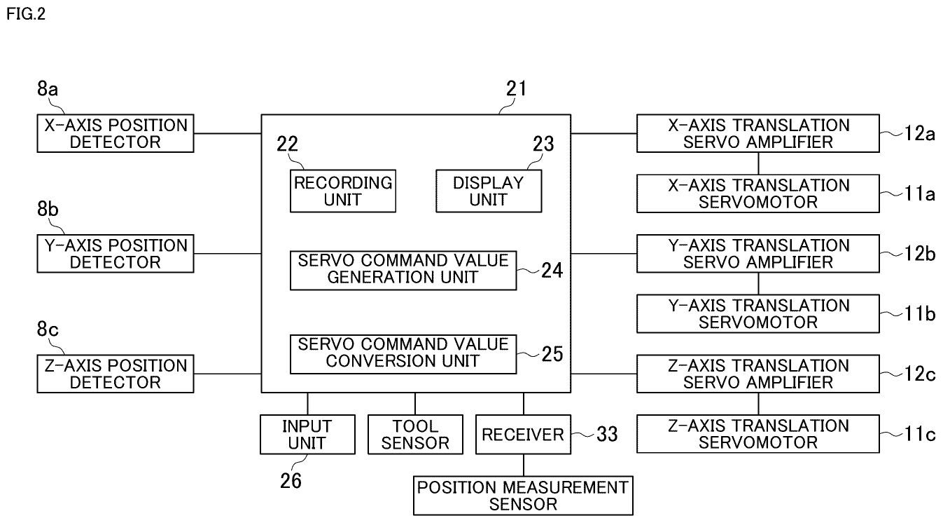

The numerical control machine tool M in the disclosure is, as illustrated in FIGS. 1 and 2, a machining center-based machine tool with three translational axes of an X-axis, a Y-axis, and a Z-axis. The numerical control machine tool M includes a bed 1, a main spindle 2 to which a tool (not illustrated) is mountable, a table 3 that can hold a workpiece (not illustrated), and an NC control device 21. Further, the numerical control machine tool M includes a tool sensor and a position measurement sensor.

The numerical control machine tool M preferably includes a magazine in which a plurality of tools are stored, and a tool changer that can automatically exchange a tool mounted to the main spindle 2 for a tool stored in the magazine. When a reference tool 10 and a position measurement sensor described later are stored in the magazine, they can be automatically attached to and removed from the main spindle 2, thus improving workability. The tool may be manually attached to and removed from the main spindle 2 by an operator.

The numerical control machine tool M is what is called a gantry-type machine tool. Therefore, a saddle 6 is movably provided at rails 5 that are formed at a column 4 and extend in the X-axis direction. The saddle 6 is provided with a main spindle ram 7 movable in the Z-axis direction. The main spindle ram 7 has a lower end at which the main spindle 2 is provided. Accordingly, the main spindle 2 can move along the Z-axis and the X-axis that are two translational axes orthogonal to each other. Specifically, the main spindle 2 can perform a translational motion of two degrees of freedom with respect to the bed 1. A feed axis is driven by an X-axis translation servomotor 11a to move the saddle 6 so that the main spindle 2 moves in the X-axis direction. A feed axis is driven by a Z-axis translation servomotor 11c to move the main spindle ram 7 so that the main spindle 2 moves in the Z-axis direction. An X-axis position detector 8a is provided on a surface in the column 4 side of the saddle 6. A Z-axis position detector 8c is provided on a surface in the saddle 6 side of the main spindle ram 7.

The table 3 is formed at the bed 1, and movably provided on rails 9 extending along the Y-axis that is a translational axis orthogonal to the Z-axis and the X-axis. Specifically, the table 3 can perform a translational motion of one degree of freedom with respect to the bed 1. A feed axis is driven by a Y-axis translation servomotor 11b so that the table 3 moves in the Y-axis direction. Further, a Y-axis position detector 8b is provided on a surface in the bed 1 side of the table 3.

As illustrated in FIG. 2, the NC control device 21 has functions as a recording unit 22, a display unit 23, and a servo command value generation unit 24. The NC control device 21 includes a CPU and a memory connected to the CPU, and uses them to achieve various kinds of processes.

The recording unit 22 is configured to record information, such as a machining program input from an input unit 26 described later, a length of the reference tool 10, a sensing position of the tool sensor, a relative position of a reference portion with respect to the sensing position, a compensation value in a length direction of the position measurement sensor.

The recording unit 22 stores programs to cause the NC control device 21 to function as a tool sensor sensing position measuring unit, a position measurement sensor length calculating unit, a relative position obtaining unit, the reference tool distal end position measuring unit, a tool sensor position measuring unit, and a position measurement sensor length direction compensation value calculating unit.

The display unit 23 is, for example, a monitor. The display unit 23 displays information, such as a machining program and respective positions of the translational axes.

The NC control device 21 is connected to the X-axis position detector 8a, the Y-axis position detector 8b, the Z-axis position detector 8c, an X-axis translation servo amplifier 12a, a Y-axis translation servo amplifier 12b, and a Z-axis translation servo amplifier 12c. The servo amplifiers 12a to 12c are further connected to the X-axis translation servomotor 11a, the Y-axis translation servomotor 11b, and the Z-axis translation servomotor 11c, respectively. Accordingly, the NC control device 21 appropriately drives the servomotors 11a to 11c based on the position information of the respective axes obtained from the position detectors 8a to 8c, thereby executing the machining of the workpiece held by the table 3 with the tool held by the main spindle 2.

Here, an exemplary method of generating a servo command value of the translational axis executed by the servo command value generation unit 24, and an exemplary method of relative position control between the table 3 and the main spindle 2 based on the servo command value are described.

When the machining program is input to the NC control device 21, the servo command value generation unit 24 generates command values of the respective translational axes based on the position information from the position detectors 8a to 8c of the respective axes and the preliminarily obtained position information of the workpiece.

The generated command values of the respective translational axes are transmitted to a servo command value conversion unit 25, and converted into the servo command value. Then, the servo command values corresponding to the X-axis, the Y-axis, and the Z-axis are transmitted to the servo amplifiers 12a to 12c, respectively. The servo amplifiers 12a to 12c drive the servomotors 11a to 11c, respectively based on the obtained servo command values corresponding to the X-axis, the Y-axis, and the Z-axis. Therefore, by driving the servomotors 11a to 11c, the relative position of the main spindle 2 with respect to the table 3 is controlled.

The NC control device 21 is further connected to the tool sensor and the position measurement sensor. For the connection to the tool sensor and the position measurement sensor, a receiver may be connected to the NC control device 21 to obtain information from a sensor through a wireless connection, or the NC control device 21 may be connected to the tool sensor and the position measurement sensor by wire. In the embodiment, the NC control device 21 is assumed to be connected to the tool sensor by wire. Meanwhile, the NC control device 21 is assumed to be wirelessly connected to the position measurement sensor. Therefore, a receiver 33 to receive the signal from the position measurement sensor is connected to the NC control device 21.

The NC control device 21 is connected also to the input unit 26, such as a keyboard and a touch panel, to execute various kinds of inputs including the machining program by the operator.

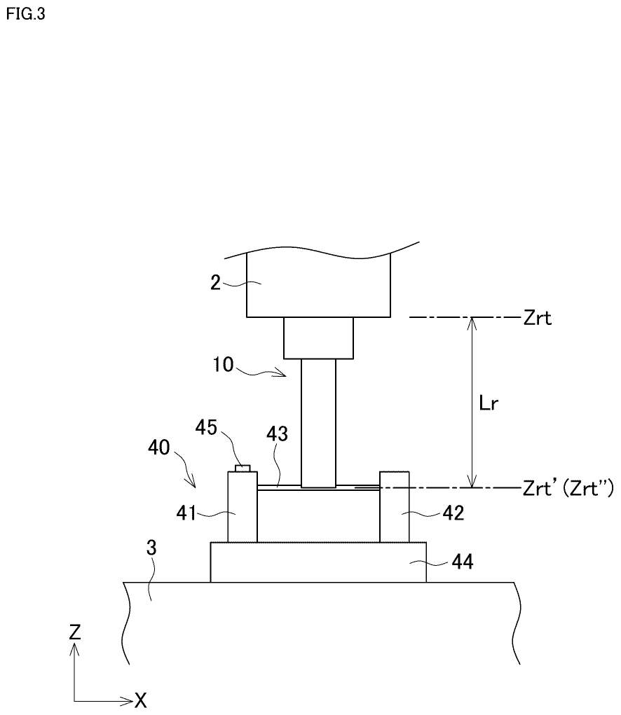

A laser sensor 40 as a tool sensor includes, as illustrated in FIG. 3, a laser emitting unit 41 that emits a laser 43 as a sensing portion, a laser receiving unit 42 that receives the laser 43, and a base portion 44. Further, the laser sensor 40 integrally includes a reference portion 45 on a top surface of the laser emitting unit 41. The reference portion 45 is formed of the same material as the laser emitting unit 41 and the laser receiving unit 42, or a material having a coefficient of linear expansion similar to those of the laser emitting unit 41 and the laser receiving unit 42. The laser sensor 40 is attached to any position of the table 3.

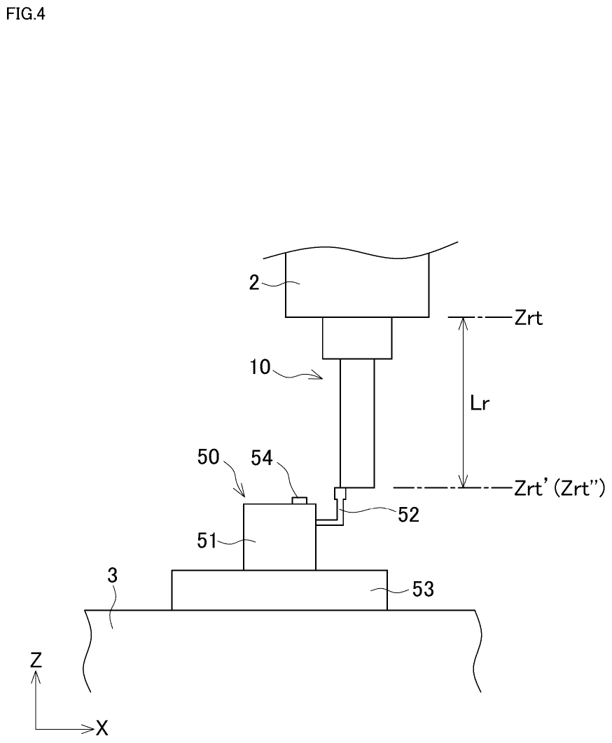

A touch sensor 50 as a tool sensor includes, as illustrated in FIG. 4, a touch sensor main body 51, a sensing portion 52 that senses the position of the tool distal end, and a base portion 53. Further, the touch sensor 50 integrally includes a reference portion 54 on a top surface of the touch sensor main body 51. The reference portion 54 is formed of the same material as the sensing portion 52 and the touch sensor main body 51, or a material having a coefficient of linear expansion similar to those of the sensing portion 52 and the touch sensor main body 51. The touch sensor 50 is attached to any position of the table 3.

Here, in the disclosure, the similar coefficient of linear expansion means a coefficient of linear expansion having a similarity that does not cause the change of the relative position between the sensing portion and the reference portion, in an environmental temperature range observed in the machining of the workpiece by the numerical control machine tool M. Or, the similar coefficient of linear expansion means a coefficient of linear expansion having a similarity to the extent that a machined product falls within an acceptable quality range even when the relative position changes, in an environmental temperature range observed in the machining of the workpiece by the numerical control machine tool M.

Based on various kinds of factors, such as a structure and an installation environment of the numerical control machine tool M, any of the laser sensor 40 and the touch sensor 50 is selected and installed in the numerical control machine tool M.

Thus, in the compensation value calculation system of the position measurement sensor according to the disclosure, the laser sensor 40 includes the reference portion 45 on the laser emitting unit 41. The reference portion 45 is formed of the same material as the laser emitting unit 41 and the laser receiving unit 42 or a material having the coefficient of linear expansion similar to those of the laser emitting unit 41 and the laser receiving unit 42. Therefore, even when the laser emitting unit 41 is thermally distorted due to the temperature change around the laser sensor 40, the relative position between the laser 43 and the reference portion 45 is less likely to change. Similarly, the touch sensor 50 includes the reference portion 54 formed of the same material as the sensing portion 52 and the touch sensor main body 51 or a material having the coefficient of linear expansion similar to those of the sensing portion 52 and the touch sensor main body 51 on the touch sensor main body 51. Therefore, even when the touch sensor main body 51 is thermally distorted due to the temperature change around the touch sensor 50, the relative position between the sensing portion 52 and the reference portion 54 is less likely to change. Accordingly, the error generated in the calculation of the compensation value in the length direction of the position measurement sensor described later can be minimized.

The reference portion 45 is provided integrally with the laser sensor 40. Similarly, the reference portion 54 is provided integrally with the touch sensor 50. Accordingly, the table region on which the workpiece is placed can be increased.

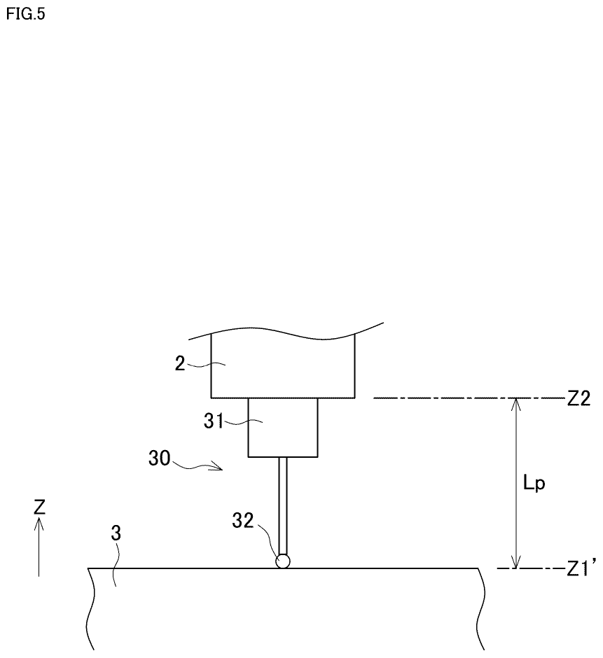

A touch trigger probe 30 as the position measurement sensor includes, as illustrated in FIG. 5, a touch trigger probe main body 31, a stylus 32 attached to the distal end, and the receiver 33 connected to the NC control device 21.

As described above, to measure the position of a measurement object, such as a workpiece, using the touch trigger probe 30, it is necessary to preliminarily obtain the compensation value in the length direction of the touch trigger probe 30 and record it in the recording unit 22 of the NC control device 21.

The following describes a calculation method of the compensation value in the length direction of the touch trigger probe 30 according to the disclosure.

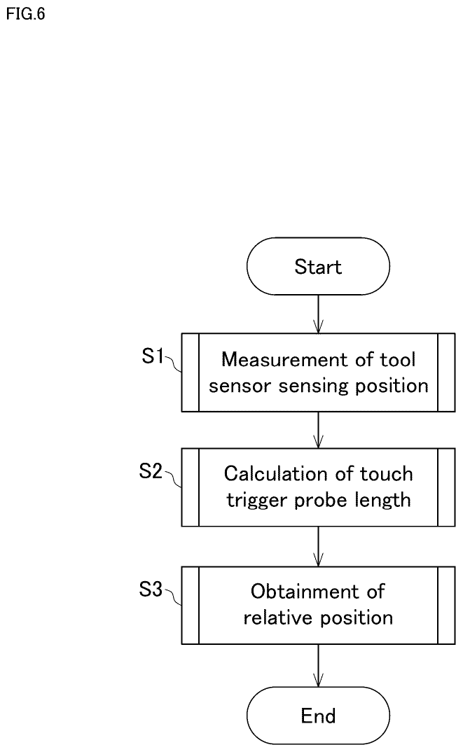

First, obtainment of the relative position between the sensing portion and the reference portion of the tool sensor, which is a setting in advance of the calculation of the compensation value in the length direction of the touch trigger probe 30 according to the disclosure, is described based on a flowchart of FIG. 6.

To perform a tool measurement using the tool sensor, it is necessary to preliminarily obtain the sensing position of the tool sensor and record it in the recording unit 22 of the NC control device 21. Therefore, in S1, a sensing position that is a position to sense the position of the distal end of the tool of the laser sensor 40 or the touch sensor 50 as the tool sensor is measured. S1 is a tool sensor sensing position measuring step in the disclosure. Here, the measurement of the sensing position in the Z-axis direction of the tool distal end is described as an example.

First, the reference tool 10 having a known length is mounted to the main spindle 2. Then, the main spindle 2 is positioned such that the distal end of the reference tool 10 is positioned immediately above the laser 43. Subsequently, as illustrated in FIG. 3, the Z-axis (feed axis) is operated in the negative direction. Then, when the laser 43 is interrupted by the distal end of the reference tool 10, it is determined to be sensed, and the laser receiving unit 42 transmits a signal to the NC control device 21. When the signal from the laser sensor 40 is received, the NC control device 21 stops the Z-axis translation servomotor 11c. In the NC control device 21, a sensing position Zrt′ is measured by using a Z-axis position Zrt when the signal is received and a length Lr of the reference tool 10 is measured by calculation using a formula (1). The measured sensing position Zrt′ is the sensing position in the Z-axis direction to sense the position of the tool distal end and to be obtained in advance. The sensing position Zrt′ is recorded in the recording unit 22.

$${Zrt}^{′} = Zrt - Lr \qquad ( 1 )$$

A method of tool measurement using the touch sensor 50 is inherently similar to the above-described case of executing the tool measurement using the laser sensor 40 excluding the sensing method. In the case of the touch sensor 50, as illustrated in FIG. 4, when the distal end of the tool comes into contact with the sensing portion 52 of the touch sensor 50, it is determined to be sensed, and the touch sensor main body 51 transmits a signal to the NC control device 21.

After measuring the sensing position Zrt′ of the tool sensor, in S2, a length of the touch trigger probe 30 is calculated. S2 is a position measurement sensor length calculating step in the disclosure.

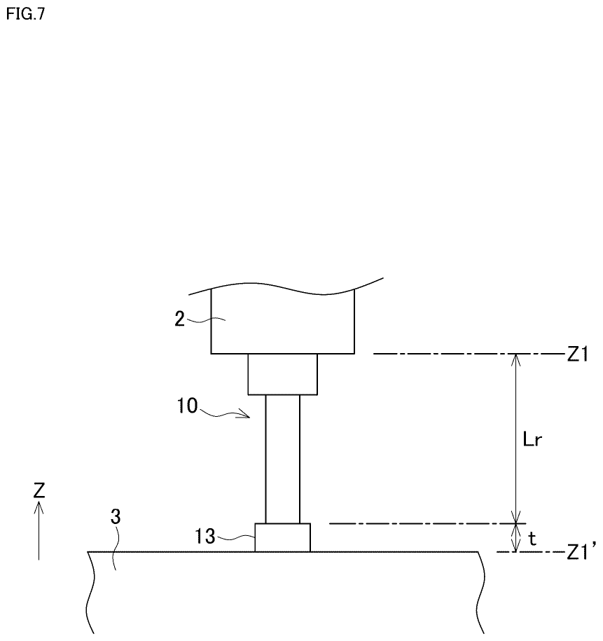

Similar to S1, the reference tool 10 is mounted to the main spindle 2, and the main spindle 2 is positioned such that the distal end of the reference tool 10 is positioned in the proximity of the top surface of the table 3. Then, as illustrated in FIG. 7, the distal end of the reference tool 10 is brought into contact with a reference block 13 that is arranged on the table 3 and has a known thickness. By using the Z-axis position detector 8c, the contact position between the reference tool 10 and the reference block 13 is obtained as a position Z1 of the top surface of the table via a known thickness t of the reference block 13. Thus, a reference position Z1′ is obtained from the obtained position Z1, the thickness t of the reference block 13, and a length Lr of the reference tool 10 by calculation using a formula (2).

$$Z {1}^{′} = Z 1 - Lr - t \qquad ( 2 )$$

Subsequently, the touch trigger probe 30 is mounted to the main spindle 2, and the main spindle 2 is positioned such that a distal end of the stylus 32 is positioned in the proximity of the position at which the reference position Z1′ is obtained. Then, as illustrated in FIG. 5, the Z-axis (feed axis) is operated in the negative direction. When the stylus 32 comes into contact with the reference position Z1′, the touch trigger probe main body 31 transmits a signal to the receiver 33 connected to the NC control device 21. A contact position Z2 at the time is a position-measurement-sensor-reference-position in the disclosure. A length Lp of the touch trigger probe is calculated from the contact position Z2 as the position-measurement-sensor-reference-position and the reference position Z1′ by calculation using a formula (3), and recorded in the recording unit 22.

$$Lp = Z 2 - Z {1}^{′} \qquad ( 3 )$$

After calculating the length Lp of the touch trigger probe 30, in S3, the relative position of the reference portion 45 with respect to the laser 43 as the sensing portion of the laser sensor 40 or the relative position of the reference portion 54 with respect to the sensing portion 52 of the touch sensor 50 is obtained. S3 is a relative position obtaining step in the disclosure.

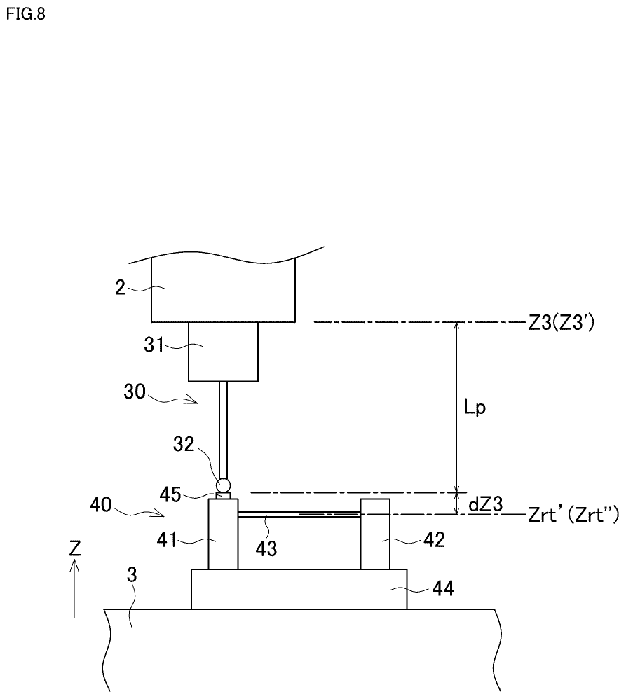

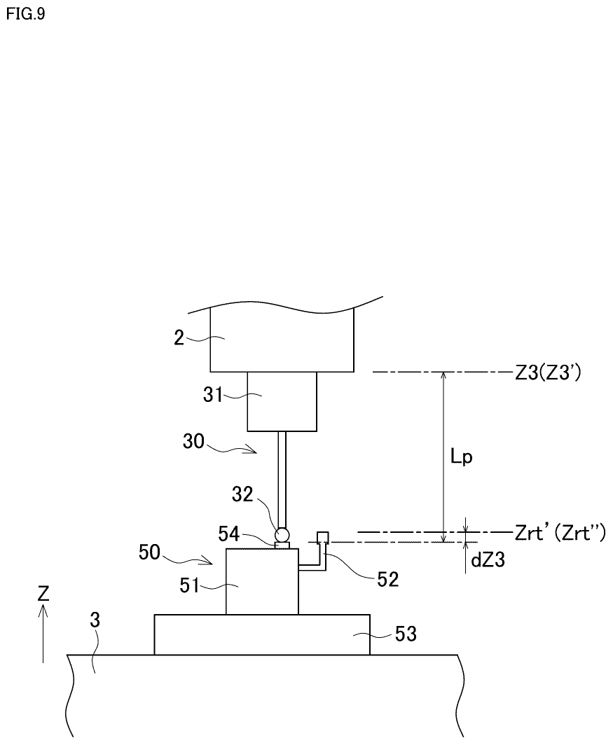

As illustrated in FIGS. 8 and 9, the main spindle 2 is positioned such that the distal end of the stylus 32 of the touch trigger probe 30 mounted to the main spindle 2 is positioned in the proximity of the reference portion 45 of the laser sensor 40 or the reference portion 54 of the touch sensor 50. Then, the Z-axis (feed axis) is operated in the negative direction. When the stylus 32 comes into contact with the reference portion 45 of the laser sensor 40 or the reference portion 54 of the touch sensor 50, the touch trigger probe main body 31 transmits a signal to the receiver 33 connected to the NC control device 21. A relative position dZ3 is obtained from the contact position Z3 at the time, the sensing position Zrt′ and the length Lp of the touch trigger probe 30 by calculation using a formula (4), and the obtained relative position dZ3 is recorded in the recording unit 22.

$$dZ 3 = Z 3 - Lp - {Zrt}^{′} \qquad ( 4 )$$

As described above, by executing S1 to S3 to store the relative position dZ3 of the reference portions 45, 54 with respect to the sensing portions 43, 52 of the laser sensor 40 or the touch sensor 50, the setting in advance of the calculation of the compensation value in the length direction of the touch trigger probe 30 is completed.

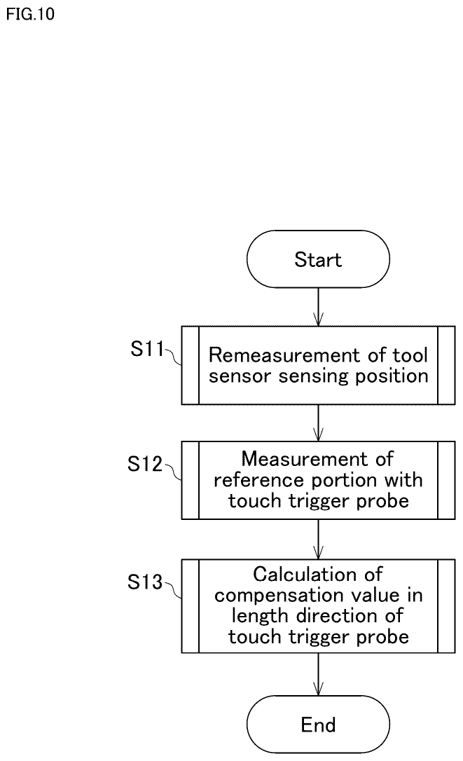

Next, a calculation method of the compensation value in the length direction of the touch trigger probe 30 executed after the completion of the setting in advance is described based on a flowchart of FIG. 10.

In S11, a remeasurement of the sensing position of the tool sensor is executed. Through the procedure similar to S1 described above, as illustrated in FIGS. 3 and 4, a sensing position Zrt″ is measured. S11 is a reference tool distal end position measuring step in the disclosure.

In S12, the touch trigger probe 30 is mounted to the main spindle 2, and the main spindle 2 is positioned such that the distal end of the stylus 32 is positioned in the proximity of the position of the reference portion 45 of the laser sensor 40 or the reference portion 54 of the touch sensor 50 measured in S3. Then, as illustrated in FIGS. 8 and 9, the Z-axis (feed axis) is operated in the negative direction. When the stylus 32 is brought into contact with the reference portion 45 of the laser sensor 40 or the reference portion 54 of the touch sensor 50, a contact position Z3′ is measured. The contact position Z3′ is a sensor position in the disclosure, and S12 is a tool sensor position measuring step.

Then, in S13, a compensation value Lp′ in the length direction of the touch trigger probe 30 is calculated from the sensing position Zrt″ measured in S11, the contact position Z3′ obtained in S12, and the relative position dZ3 obtained in S3 and recorded in the recording unit 22 by calculation using a formula (5), and the compensation value Lp′ is recorded in the recording unit 22. S13 is a position measurement sensor length direction compensation value calculating step in the disclosure.

In the compensation value calculation method of the position measurement sensor according to the disclosure, when S1 to S3 as the setting in advance of the calculation of the compensation value in the length direction of the touch trigger probe 30 is executed once, S11 to S13 may be executed multiple times.

$${Lp}^{′} = Z {3}^{′} - {Zrt}^{″} - dZ 3 \qquad ( 5 )$$

The compensation value Lp′ in the length direction of the touch trigger probe 30 calculated as described above is used for compensating the measurement position in the measurement of the workpiece position.

In the compensation value calculation method of the position measurement sensor according to the disclosure, as the tool sensor, the laser sensor 40 that includes the reference portion 45 formed of the same material as the laser emitting unit 41 and the laser receiving unit 42 or a material having the coefficient of linear expansion similar to those of the laser emitting unit 41 and the laser receiving unit 42 on the laser emitting unit 41 is used. Therefore, even when the laser emitting unit 41 is thermally distorted due to the temperature change around the laser sensor 40, the relative position between the laser 43 and the reference portion 45 is less likely to change. In the case where the touch sensor 50 is used as the tool sensor, similarly, the touch sensor 50 includes the reference portion 54 formed of the same material as the sensing portion 52 and the touch sensor main body 51 or a material having the coefficient of linear expansion similar to those of the sensing portion 52 and the touch sensor main body 51 on the touch sensor main body 51. Therefore, even when the touch sensor main body 51 is thermally distorted due to the temperature change around the touch sensor 50, the relative position between the sensing portion 52 and the reference portion 54 is less likely to change. Accordingly, the error generated in the calculation of the compensation value in the length direction of the position measurement sensor can be minimized.

The configurations of the method and the system of calculating the compensation value of the position measurement sensor in the machine tool according to the disclosure are not limited to the aspects of the above-described embodiment and can be appropriately changed as necessary without departing from the gist of the disclosure.

For example, the position of the reference portion does not need to be arranged on the top surface of the tool sensor insofar as the reference portion is provided integrally with the tool sensor in the proximity of the sensing portion. While the reference portion is emphasized in the above-described embodiment and the drawings, a predetermined portion excluding the sensing portion in the tool sensor may be used as the reference portion.

While the laser sensor, the touch sensor, and the touch trigger probe are described as the examples of the tool sensor and the position measurement sensor, other sensors may be used.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A compensation value calculation method of a position measurement sensor in a machine tool for calculating a compensation value in a length direction of the position measurement sensor, wherein
the machine tool includes:
a table configured to hold a workpiece;
a rotatable main spindle to which a tool is mounted;
a translational axis configured to perform a relative motion of the main spindle and the table with two degrees or more of translational freedom; and
a tool sensor configured to measure a position of the tool mounted to the main spindle,
the machine tool is configured to measure a position of the workpiece held by the table with the position measurement sensor mountable to the main spindle, and
the tool sensor includes a sensing portion that senses a sensing object and a reference portion that is provided integrally with the tool sensor in a proximity of the sensing portion and serves as a position reference of the tool sensor, wherein
the method comprises:
a tool sensor sensing position measuring step of mounting a reference tool having a known length to the main spindle, causing the sensing portion of the tool sensor to sense a distal end of the reference tool to obtain a distal end position of the reference tool, and measuring a position of the sensing portion of the tool sensor from the obtained distal end position of the reference tool and a length of the reference tool;
a position measurement sensor length calculating step of obtaining a reference position using the reference tool mounted to the main spindle, subsequently, mounting the position measurement sensor to the main spindle, measuring the reference position using the position measurement sensor to obtain a position-measurement-sensor-reference-position, and calculating a length of the position measurement sensor from the obtained position-measurement-sensor-reference-position, the length of the reference tool, and the reference position;
a relative position obtaining step of mounting the position measurement sensor to the main spindle, measuring a position of the reference portion, and obtaining a relative position of the position of the reference portion with respect to the position of the sensing portion from the measured position of the reference portion, the position of the sensing portion measured in the tool sensor sensing position measuring step, and the length of the position measurement sensor calculated in the position measurement sensor length calculating step;
a reference tool distal end position measuring step of mounting the reference tool to the main spindle, bringing the distal end of the reference tool into contact with the sensing portion, and measuring a position of the distal end of the reference tool;
a tool sensor position measuring step of measuring a position of the tool sensor by mounting the position measurement sensor to the main spindle and measuring the position of the reference portion; and
a position measurement sensor length direction compensation value calculating step of calculating the compensation value in the length direction of the position measurement sensor from the length of the reference tool, the relative position obtained in the relative position obtaining step, the position of the distal end of the reference tool measured in the reference tool distal end position measuring step, and the position of the tool sensor measured in the tool sensor position measuring step.

2. The compensation value calculation method of a position measurement sensor in a machine tool according to claim 1, wherein
the tool sensor sensing position measuring step to the relative position obtaining step are executed once, and
the reference tool distal end position measuring step to the position measurement sensor length direction compensation value calculating step are executed multiple times.

3. The compensation value calculation method of a position measurement sensor in a machine tool according to claim 1, wherein
the sensing portion and the reference portion are formed of a material that does not cause a change of the relative position between the sensing portion and the reference portion in an environmental temperature range observed in the machining by the machine tool.

4. A compensation value calculation system of a position measurement sensor in a machine tool for calculating a compensation value in a length direction of the position measurement sensor, wherein
the machine tool includes:
a table configured to hold a workpiece;
a rotatable main spindle to which a tool is mounted;
a translational axis configured to perform a relative motion of the main spindle and the table with two degrees or more of translational freedom;
a control device that controls the table, the translational axis, and the main spindle; and
a tool sensor configured to measure a position of the tool mounted to the main spindle,
the machine tool is configured to measure a position of the workpiece held by the table with the position measurement sensor mountable to the main spindle, and
the tool sensor includes a sensing portion that senses a sensing object and a reference portion that is provided integrally with the tool sensor in a proximity of the sensing portion and serves as a position reference of the tool sensor, wherein
the system comprises:
a reference tool having a known length;
a tool sensor sensing position measuring unit that mounts the reference tool to the main spindle, operates the translational axis, causes the sensing portion of the tool sensor to sense a distal end of the reference tool to obtain a distal end position of the reference tool, and measures a position of the sensing portion of the tool sensor from the obtained distal end position of the reference tool and a length of the reference tool;
a position measurement sensor length calculating unit that mounts the reference tool to the main spindle and operates the translational axis to obtain a reference position, subsequently, mounts the position measurement sensor to the main spindle, operates the translational axis to measure the reference position using the position measurement sensor to obtain a position-measurement-sensor-reference-position, and calculates a length of the position measurement sensor from the length of the reference tool, the reference position, and the position-measurement-sensor-reference-position;
a relative position obtaining unit that mounts the position measurement sensor to the main spindle, operates the translational axis to measure a position of the reference portion, and obtains a relative position of the position of the reference portion with respect to the position of the sensing portion from the measured position of the reference portion, the position of the sensing portion measured by the tool sensor sensing position measuring unit, and the length of the position measurement sensor calculated by the position measurement sensor length calculating unit;
a reference tool distal end position measuring unit that mounts the reference tool to the main spindle, operates the translational axis to bring the distal end of the reference tool into contact with the sensing portion, and measures a position of the distal end of the reference tool;
a tool sensor position measuring unit that measures a position of the tool sensor by mounting the position measurement sensor to the main spindle and operating the translational axis to measure the position of the reference portion; and
a position measurement sensor length direction compensation value calculating unit that calculates the compensation value in the length direction of the position measurement sensor from the length of the reference tool, the relative position obtained by the relative position obtaining unit, the position of the distal end of the reference tool measured by the reference tool distal end position measuring unit, and the position of the tool sensor measured by the tool sensor position measuring unit.

5. The compensation value calculation system of a position measurement sensor in a machine tool according to claim 4, wherein
the sensing portion and the reference portion are formed of a material that does not cause a change of the relative position between the sensing portion and the reference portion in an environmental temperature range observed in the machining by the machine tool.
